(19) United States
(12) Patent Application Publication
(10) Pub. No.: US 2010/0061120 A1
(43) Pub. Date: Mar. 11, 2010

(54) Frame For Back Light Module

(75) Inventors: Ke-Feng Lin, Tu-Cheng City (TW); Chi-Ming Tseng, Tu-Cheng City (TW); Guan-Yi Liu, Tu-Cheng City (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/206,099

(22) Filed: Sep. 8, 2008

(51) Int. Cl. F21V 7/04

(52) U.S. Cl. 362/633

(57) ABSTRACT

A frame for back light module is disclosed that includes a chassis and an insulating housing integrally formed with the chassis. The chassis has a bottom wall and plural sidewalls extending from the bottom wall. At least one sidewall defines at least one locking structure on a free end surface thereof. The insulating housing has plural sideboards respectively integrally formed with inner surfaces of the sidewalls of the chassis. At least one sideboard defines at least one mating structure integrally engaged with the locking structure of the chassis.

### BACKGROUND OF THE INVENTION

1. Field of the Invention

The present invention relates to a back light module, and more particularly to a frame for back light module.

2. The Related Art

With the development of electronic technology, liquid crystal panels are broadly used in notebook computers, television sets, digital cameras and so on. A back light module is a key component of the liquid crystal panel. The back light module provides the liquid crystal panel with a light source of sufficient brightness and uniformity, as the liquid crystal panel by itself cannot emit light. After assembled with the back light module, the liquid crystal panel can normally display images.

Conventionally, the back light module has a mold frame defining a plurality of protrusions on lateral sides thereof and a chassis fabricated by bending a thin metal sheet. The chassis defines a plurality of holes on edges thereof for receiving the protrusions of the mold frame respectively, so that the rigidity of the mold frame is enhanced and the mold frame is capable of reliably receiving and supporting optical elements of the back light module and the liquid crystal panel therein.

However, the assembly of the mold frame with the chassis utilizes the protrusions of the mold frame being located in the holes of the chassis, so the firmness between the mold frame and the chassis is weak. In order to overcome the disadvantage, an insert molding method is adopted to inject molten plastic material in a mold through the holes of the chassis to form the mold frame integrally with the chassis. However, due to limitation of the structure of the chassis, it takes extremely long time for the molten plastic to be solidified in the process of forming integrally with the chassis such that the output efficiency of the mold frame is reduced.

### SUMMARY OF THE INVENTION

Accordingly, an object of the present invention is to provide a frame for back light module. The frame for back light module includes a chassis and an insulating housing integrally formed with the chassis. The chassis has a bottom wall and a plurality of sidewalls extending from the bottom wall. At least one sidewall defines at least one locking structure on a free end surface thereof. The insulating housing has a plurality of sideboards respectively integrally formed with inner surfaces of the sidewalls of the chassis. At least one sideboard defines at least one mating structure integrally engaged with the locking structure of the chassis.

As described above, the chassis defines the locking structure on the free end surface of the sidewall thereof to engage with the insulating housing formed by making molten plastic material injected in a mold, so that the rigidity of the frame is increased and further more, the liquidity of the molten plastic material in the mold is increased. Thereby, the holdup time of the molten plastic material in the process of forming the insulating housing integrally with the chassis is shortened, which in turn increases the output efficiency of the frame.

### BRIEF DESCRIPTION OF THE DRAWINGS

The present invention will be apparent to those skilled in the art by reading the following description of preferred embodiments thereof, with reference to the attached drawings, in which:

FIG. 1 is an exploded view of a frame for back light module of a first embodiment according to the present invention;

FIG. 2 is a perspective view of the frame of FIG. 1 while in an assembled state;

FIG. 3 is an exploded view of a frame for back light module of a second embodiment according to the present invention; and

FIG. 4 is an exploded view of a frame for back light module of a third embodiment according to the present invention.

### DETAILED DESCRIPTION OF THE PREFERRED EMBODIMENTS

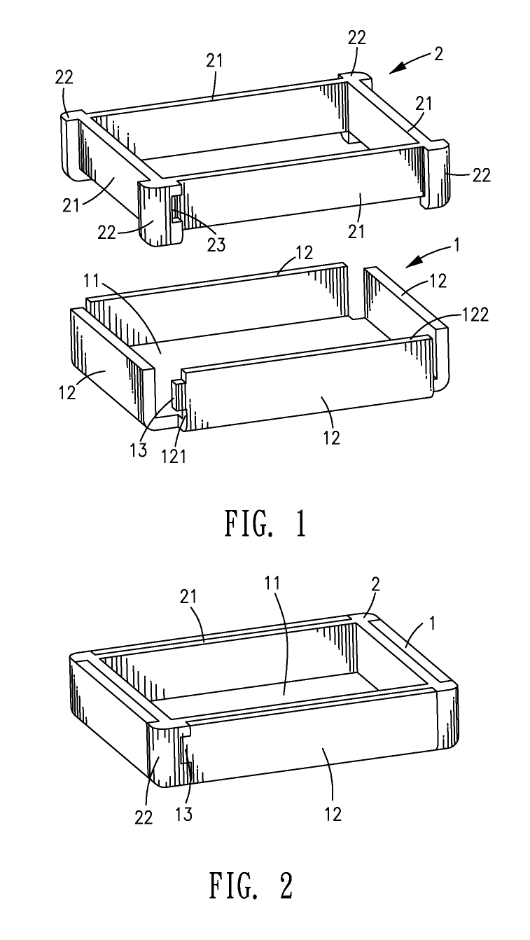

Referring to FIG. 1 and FIG. 2, a frame for back light module of a first embodiment in accordance with the present invention includes a metal chassis 1 and an insulating housing 2 integrally formed with the metal chassis 1 through a method of insert molding.

The metal chassis 1 has a bottom wall 11 and four sidewalls 12 extending upward from four edges of the bottom wall 11. Any of two adjacent sidewalls 12 keep an interval therebetween. Each of the sidewalls 12 defines two side surfaces 121 at opposite free ends thereof and a top surface 122 at a top end thereof. At least one side surface 121 protrudes in part and outward to form a rectangular protrusion lump 13 at a substantially middle portion thereof.

The insulating housing 2 is integrally formed with the metal chassis 1 by injecting molten plastic material into a mold (not shown). The insulating housing 2 forms four sideboards 21 orderly connected with each other. The junction of adjacent two of the sideboards 21 protrudes outwardly to form a bump 22. At least one bump 22 defines a rectangular gap 23. The sideboards 21 are correspondingly tightly attached to inner surfaces of the sidewalls 12 of the metal chassis 1. The bump 22 is stuffed in the interval between adjacent two of the sidewalls 12 and the protrusion lump 13 of the metal chassis 1 is engaged with the gap 23.

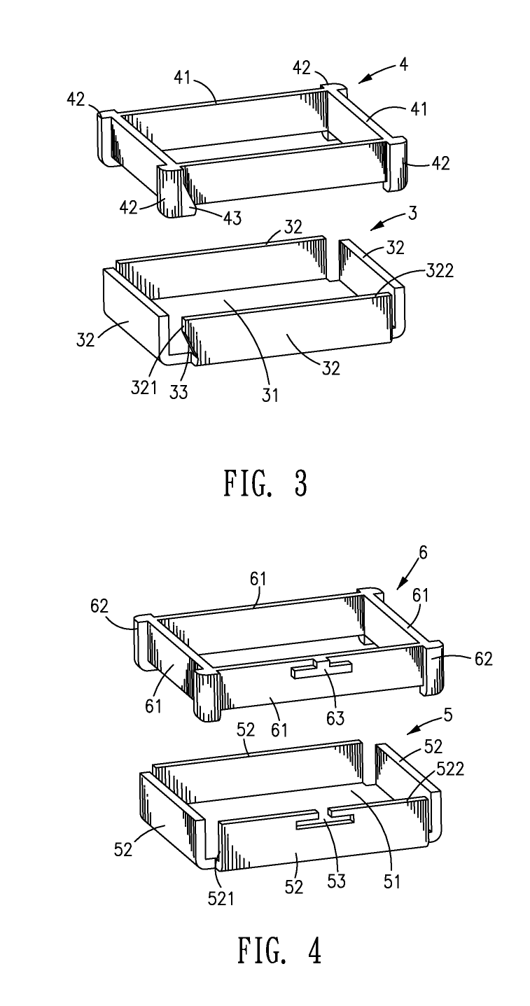

With reference to FIG. 3, a frame for back light module of a second embodiment in accordance with the present invention includes a metal chassis 3 and an insulating housing 4 integrally formed with the metal chassis 3 through a method of insert molding. The metal chassis 3 has a bottom wall 31 and four sidewalls 32. Adjacent two of the sidewalls 32 keep an interval therebetween. Each of the sidewalls 32 defines two side surfaces 321 and a top surface 322 opposite to the bottom wall 31. At least one side surface 321 is slantways cut from a substantial middle portion to a bottom portion thereof to define a gap 33 for example a wedge-shaped gap. The insulating housing 4 is integrally formed with the metal chassis 3 by injecting molten plastic material into a mold (not shown). The insulating housing 4 has four sideboards 41 and four bumps 42 each of which is formed at the junction of adjacent two of the sideboards 41. At least one bump 42 projects toward the adjacent sideboard 41 to form a protrusion lump 43 of substantially right triangle-shape. The sideboards 41 are correspondingly tightly attached to inner surfaces of the sidewalls 32 of the metal chassis 3. The bump 42 is stuffed in the interval between adjacent two of the sidewalls 32 and the protrusion lump 43 is engaged with the gap 33.

Referring to FIG. 4, a frame for back light module of a third embodiment according to the present invention includes a metal chassis 5 and an insulating housing 6 integrally formed with the metal chassis 5 through a method of insert molding. The metal chassis 5 has a bottom wall 51 and four sidewalls 52. Adjacent two of the sidewalls 52 keep an interval therebetween. Each of the sidewalls 52 defines two side surfaces 521 and a top surface 522 opposite to the bottom wall 51. At least one top surface 522 defines an inversely T-shaped gap 53. The insulating housing 6 is integrally formed with the metal chassis 5 by injecting molten plastic material into a mold (not shown). The insulating housing 6 has four sideboards 61 and four bumps 62 each of which is formed at the junction of adjacent two of the sideboards 61. At least one sideboard 61 defines an inversely T-shaped protrusion lump 63 on an outer side surface thereof. The sideboards 61 are correspondingly tightly attached to inner surfaces of the sidewalls 52 of the metal chassis 5. The bump 62 is stuffed in the interval between adjacent two of the sidewalls 52 and the protrusion lump 63 is engaged with the gap 53.

As described above, the metal chassis 1, 3, 5 defines at least one locking structure on one free end surface of the sidewalls 12, 32, 52 thereof to engage with the insulating housing 2, 4, 6, so that the rigidity of the frame is increased and further more, the liquidity of the molten plastic material in the mold is increased. Thereby, the holdup time of the molten plastic material in the process of forming the insulating housing 2, 4, 6 integrally with the metal chassis 1, 3, 5 is shortened, which increases the output efficiency of the frame.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A frame for back light module, comprising:
a chassis having a bottom wall and a plurality of sidewalls extending from the bottom wall, at least one sidewall defining at least one locking structure on a free end surface thereof; and
an insulating housing having a plurality of sideboards respectively integrally formed with inner surfaces of the sidewalls of the chassis, at least one sideboard forming at least one mating structure integrally engaged with the locking structure of the chassis.

2. The frame for back light module as claimed in claim 1, wherein two adjacent sidewalls of the chassis define an interval therebetween, and the junction of two adjacent sideboards of the insulating housing forms a bump integrally engaged with the interval of the chassis.

3. The frame for back light module as claimed in claim 2, wherein the sidewall of the chassis defines a side surface adjacent to the interval to perform as the free end surface, the side surface protrudes to form a protrusion lump, and the bump of the insulating housing defines a gap therein to engage the protrusion lump.

4. The frame for back light module as claimed in claim 2, wherein the sidewall of the chassis defines a side surface adjacent to the interval to perform as the free end surface, the side surface is cut to define a gap, and the bump projects to form a protrusion lump to be engaged with the gap.

5. The frame for back light module as claimed in claim 1, wherein the sidewall of the chassis defines a top surface opposite the bottom wall to perform as the free end surface, the top surface defines a gap, the sideboard of the insulating housing defines a protrusion lump on an outer side surface thereof, and the protrusion lump is engaged in the gap.

6. The frame for back light module as claimed in claim 5, wherein the gap is of an inversed T-shape.
